(19) United States
(12) Patent Application Publication
(10) Pub. No.: US 2025/0118858 A1
(43) Pub. Date: Apr. 10, 2025

(54) BATTERY ARRAYS WITH STAGGERED VENTING HOLE DESIGNS

(71) Applicant: FORD GLOBAL TECHNOLOGIES, LLC, Dearborn, MI (US)

(72) Inventors: Parikshit S. GUPTE, West Bloomfield, MI (US); Giriraj SRINIVASAN, Troy, MI (US); Bhaskara Rao BODDAKAYALA, Troy, MI (US); Scott M. ROLLINS, Highland, MI (US); Dominic Mario BERTOLINI, Birmingham, MI (US)

(21) Appl. No.: 18/483,712

(22) Filed: Oct. 10, 2023

(51) Int. Cl. H01M 50/367; B60L 50/64; H01M 10/48; H01M 10/658; H01M 50/211; H01M 50/271

(52) U.S. Cl. CPC H01M 50/367; B60L 50/64; H01M 10/482; H01M 10/658; H01M 50/211; H01M 50/271; H01M 2220/20

(57) ABSTRACT

Battery arrays are provided for traction battery packs. An exemplary battery array may include an interior component including a venting channel and an exterior component including a venting hole. The venting hole may be staggered relative to the venting channel to establish a tortuous venting path between an interior and an exterior of the battery array.

### TECHNICAL FIELD

This disclosure relates generally to traction battery packs, and more particularly to battery arrays that provide tortuous venting paths for venting battery vent byproducts from an interior of the battery array.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an interior component including a venting channel, and an exterior component including a vent hole that is staggered relative to the venting channel to establish a tortuous venting path between an interior and an exterior of the battery array.

In a further non-limiting embodiment of the foregoing battery array, the interior component is part of a battery cell sensing assembly.

In a further non-limiting embodiment of either of the foregoing battery arrays, the interior component is a base frame of the battery cell sensing assembly.

In a further non-limiting embodiment of any of the forgoing battery arrays, a thermal blocker is secured to an underside of the base frame.

In a further non-limiting embodiment of any of the forgoing battery arrays, the thermal blocker includes a second venting channel that is aligned with venting channel.

In a further non-limiting embodiment of any of the forgoing battery arrays, the exterior component is part of an array housing of the battery array.

In a further non-limiting embodiment of any of the forgoing battery arrays, the exterior component is a top cover of the array housing.

In a further non-limiting embodiment of any of the forgoing battery arrays, the interior component is positioned between the top cover and a plurality of battery cells of the battery array.

In a further non-limiting embodiment of any of the forgoing battery arrays, a bridging tab of the exterior component extends over top of at least a portion of the venting channel of the interior component.

In a further non-limiting embodiment of any of the forgoing battery arrays, the bridging tab connects between the vent hole and a second vent hole of the exterior component.

A battery array for a traction battery pack according to another exemplary aspect of the present disclosure includes, among other things, an array housing, a plurality of battery cells housed inside the array housing, and a cell sensing assembly positioned between the plurality of battery cells and a cover of the array housing. A vent hole foamed through the cover is staggered relative to a venting channel foamed through a base frame of the cell sensing assembly.

In a further non-limiting embodiment of the foregoing battery array, the cover is a top cover of the array housing.

In a further non-limiting embodiment of either of the foregoing battery arrays, a thermal blocker is secured to an underside of the base frame.

In a further non-limiting embodiment of any of the foregoing battery arrays, the thermal blocker includes a second venting channel.

In a further non-limiting embodiment of any of the foregoing battery arrays, the second venting channel is aligned with the venting channel of the base frame.

In a further non-limiting embodiment of any of the foregoing battery arrays, the vent hole is staggered relative to the venting channel to establish a tortuous venting path between an interior and an exterior of the battery array.

In a further non-limiting embodiment of any of the foregoing battery arrays, a bridging tab of the cover extends over top of at least a portion of the venting channel of the base frame.

In a further non-limiting embodiment of any of the foregoing battery arrays, the bridging tab connects between the vent hole and a second vent hole of the cover.

In a further non-limiting embodiment of any of the foregoing battery arrays, the cover is a top cover of the array housing.

In a further non-limiting embodiment of any of the foregoing battery arrays, the plurality of battery cells are arranged into at least two cell stack subassemblies that are separated by a center wall.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack. Select portions of the battery array are removed in FIG. 2 for illustrating internal components.

FIG. 3 is a partial exploded view of the battery array of FIG. 2.

FIG. 4 is a top view of a portion of the battery array of FIGS. 2 and 3.

FIG. 5 is a cross-sectional view through section 5-5 of FIG. 4.

### DETAILED DESCRIPTION

This disclosure details battery arrays for traction battery packs. An exemplary battery array may include an interior component including a venting channel and an exterior component including a venting hole. The venting hole may be staggered relative to the venting channel to establish a tortuous venting path between an interior and an exterior of the battery array. These and other features are discussed in greater detail in the following paragraphs of this detailed description.

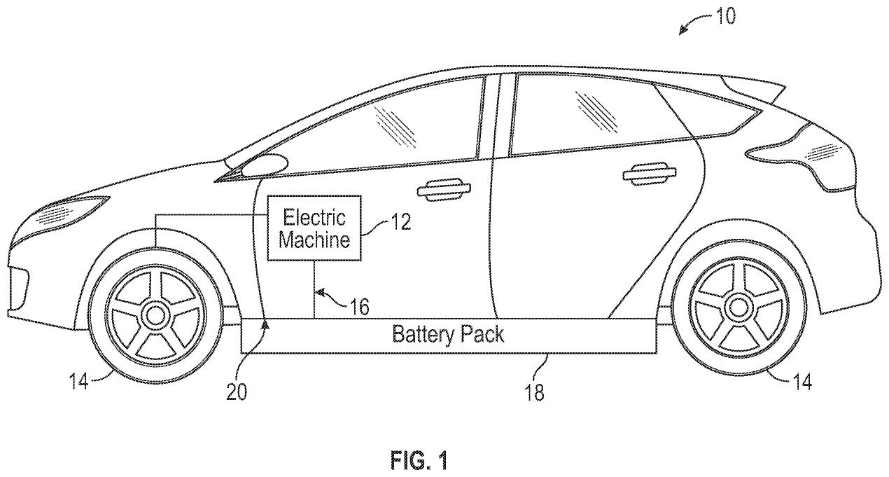

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

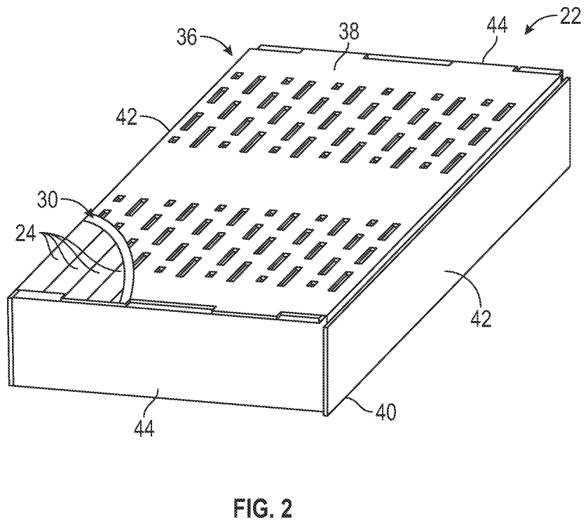

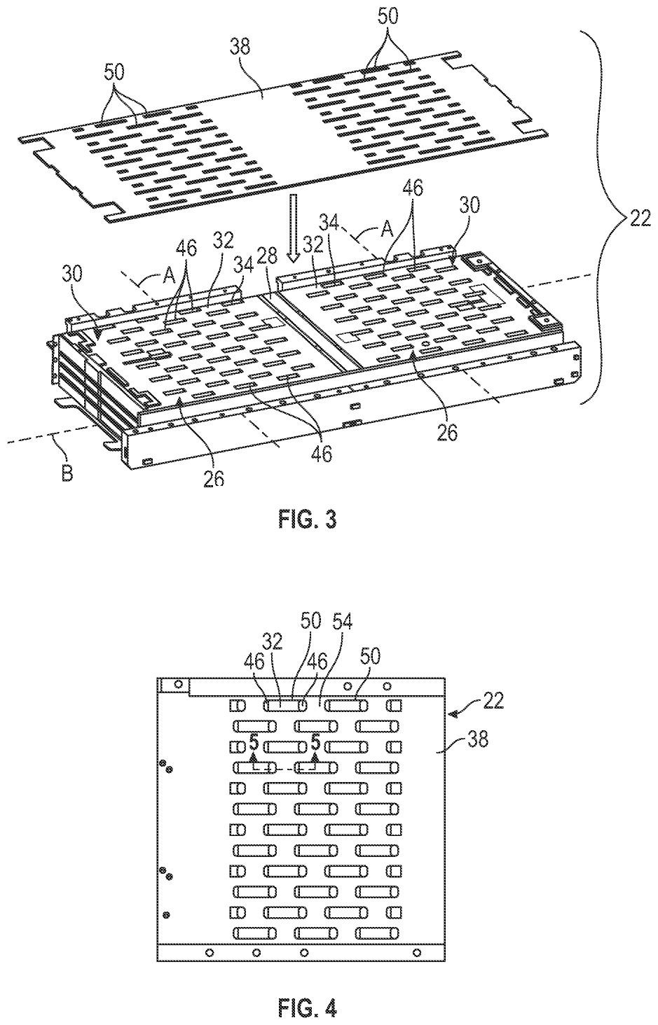

FIGS. 2, 3, 4, and 5 illustrate an exemplary battery array 22 for a traction battery pack, such as the traction battery pack 18 of FIG. 1, for example. One or more battery arrays having a design similar to the battery array 22 shown in FIGS. 2-3 could be packaged within the traction battery pack 18.

The battery array 22 may include a plurality of battery cells 24 (see cutaway portion of FIG. 2). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be grouped together in one or more cell stack subassemblies 26 that are each arranged to extend along a respective stack axis A. In the illustrated embodiment, the battery array 22 includes two cell stack subassemblies 26 that are separated from one another by a center wall 28. However, a greater or fewer number of cell stack subassemblies 26 could be provided within the battery array 22 within the scope of this disclosure. In an embodiment, the stack axes A are transverse to a longitudinal axis B of the battery array 22. However, other configurations are possible.

Each cell stack subassembly 26 may include a cell sensing assembly 30. The cell sensing assembly 30 may include sense leads and other circuitry necessary for monitoring voltage and temperature infoamation associated with the battery cells 24 of each cell stack subassembly 26 of the battery array 22.

Each cell sensing assembly 30 may include a base frame 32 and a thermal blocker 34. The thermal blocker 34 may be secured to or integrally foamed with an underside of the base frame 32 and may be configured to protect various circuitry of the cell sensing assembly 30, such as from the heat generated within the battery cells 24, for example. The thermal blocker 34 may be made of foam, mica, a woven fabric, or any other high temperature capable material within the scope of this disclosure.

The cell stack subassemblies 26, and various other internal components of the battery array 22, may be housed within an array housing 36. The array housing 36 may be arranged to substantially surround each cell stack subassembly 26, for example. The array housing 36 may include a plurality of plate members that can be arranged provide a top cover 38, a bottom cover 40, a pair of side covers 42, and a pair of end covers 44 of the battery array 22. Two or more of the top cover 38, the bottom cover 40, the side covers 42, and the end covers 44 may be foamed together as a single piece to reduce parts and complexity. For example, the bottom cover 40 and the end covers 44 may be foamed together for establishing a U-shaped structure that covers the ends and bottom of the battery array 22. However, other configurations are contemplated within the scope of this disclosure.

Each cell sensing assembly 30 may be positioned between the array housing 36 and the battery cells 24. In an embodiment, each cell sensing assembly 30 is located between the top cover 38 and the upper surfaces of the battery cells 24. However, other configurations are possible within the scope of this disclosure.

Although rare, the battery array 22 could experience a battery thermal event during its operation. A battery thermal event may occur, for example, during over-charging conditions, over-discharging conditions, or other conditions and can cause one or more of the battery cells 24 to expel battery vent byproducts that can include gases, effluent particles, and/or other vent byproducts.

The battery array 22 may include features designed for managing/mitigating the effects of battery thermal events. For example, referring now primarily to FIGS. 3, 4, and 5, a first plurality of vent channels 46 may be foamed through the base frame 32 of each cell sensing assembly 30. A second plurality of vent channels 48 may be foamed through the thermal blocker 34 of each cell sensing assembly 30. The vent channels 48 may directly align with the vent channels 46 to permit battery vent byproducts to pass through the cell sensing assembly 30 from the battery cell 24 experiencing the battery thermal event. Notably, such as when the thermal blocker 34 is made of a porous material (e.g., foam), pre-foamed or pre-cut vent channels may not be a necessary feature of the thermal blocker 34.

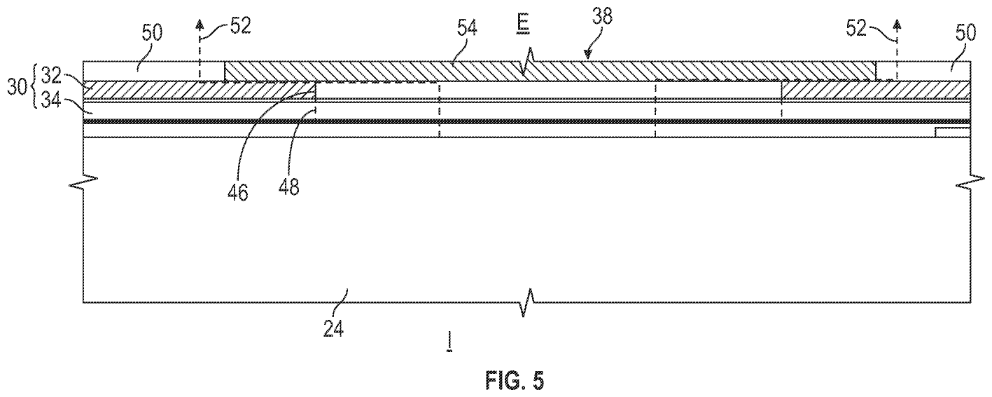

A plurality of vent holes 50 may be foamed through the top cover 38 (or any other plate member) of the array housing 36. In an assembled state of the battery array 22, the vent holes 50 may be staggered relative to the vent channels 46 to a create a tortuous venting path 52 between an interior I and an exterior E of the battery array 22 (see FIG. 5). For example, when battery vent byproducts are released by one or more of the battery cells 24 during a battery thermal event, the battery vent byproducts may travel through one or more of the vent channels 46. However, prior to exiting through the vent holes 50, the battery vent byproducts must first change direction at least once to move axially around a bridging tab 54 that connects between adjacent vent holes 50 of the top cover 38, thus slowing the speed of exiting gases.

Furthermore, the staggered relationship between the vent channels 46 and the vent holes 50 may prevent ingress of battery vent byproducts released by neighboring battery arrays and/or neighboring cell groups of the traction battery pack 18. For example, the bridging tabs 54 may at least partially block battery vent byproducts from neighboring battery arrays from entering inside the battery array 22, and the bridging tabs 54 may further at least partially block battery vent byproducts from neighboring cell groups from propagating to another cell group within the same battery array 22. The proposed designs may therefore further function to slow array-to-array and/or cell group-to-cell group propagation during battery thermal events.

The exemplary battery arrays of this disclosure include a staggered venting design that provides a tortuous venting path for releasing battery vent byproducts from the array during a battery thermal event. The staggered design functions to both reduce the speed of vent byproducts exiting the array and limit ingress of vent byproducts into the array from neighboring arrays.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an interior component including a venting channel; and
an exterior component including a vent hole that is staggered relative to the venting channel to establish a tortuous venting path between an interior and an exterior of the battery array.

2. The battery array as recited in claim 1, wherein the interior component is part of a battery cell sensing assembly.

3. The battery array as recited in claim 2, wherein the interior component is a base frame of the battery cell sensing assembly.

4. The battery array as recited in claim 3, comprising a thermal blocker secured to an underside of the base frame.

5. The battery array as recited in claim 4, wherein the thermal blocker includes a second venting channel that is aligned with venting channel.

6. The battery array as recited in claim 1, wherein the exterior component is part of an array housing of the battery array.

7. The battery array as recited in claim 6, wherein the exterior component is a top cover of the array housing.

8. The battery array as recited in claim 7, wherein the interior component is positioned between the top cover and a plurality of battery cells of the battery array.

9. The battery array as recited in claim 1, wherein a bridging tab of the exterior component extends over top of at least a portion of the venting channel of the interior component.

10. The battery array as recited in claim 9, wherein the bridging tab connects between the vent hole and a second vent hole of the exterior component.

11. A battery array for a traction battery pack, comprising:
an array housing;
a plurality of battery cells housed inside the array housing; and
a cell sensing assembly positioned between the plurality of battery cells and a cover of the array housing,
wherein a vent hole foamed through the cover is staggered relative to a venting channel foamed through a base frame of the cell sensing assembly.

12. The battery array as recited in claim 11, wherein the cover is a top cover of the array housing.

13. The battery array as recited in claim 11, comprising a thermal blocker secured to an underside of the base frame.

14. The battery array as recited in claim 13, wherein the thermal blocker includes a second venting channel.

15. The battery array as recited in claim 14, wherein the second venting channel is aligned with the venting channel of the base frame.

16. The battery array as recited in claim 11, wherein the vent hole is staggered relative to the venting channel to establish a tortuous venting path between an interior and an exterior of the battery array.

17. The battery array as recited in claim 11, wherein a bridging tab of the cover extends over top of at least a portion of the venting channel of the base frame.

18. The battery array as recited in claim 17, wherein the bridging tab connects between the vent hole and a second vent hole of the cover.

19. The battery array as recited in claim 18, wherein the cover is a top cover of the array housing.

20. The battery array as recited in claim 11, wherein the plurality of battery cells are arranged into at least two cell stack subassemblies that are separated by a center wall.
